(19) United States
(12) Patent Application Publication
(10) Pub. No.: US 2018/0068190 A1
(43) Pub. Date: Mar. 8, 2018

(54) DRIVER ASSISTANCE DEVICE AND METHOD FOR ASSISTING A DRIVER IN DRIVING A VEHICLE

(71) Applicant: CONTINENTAL AUTOMOTIVE GMBH, Hannover (DE)

(72) Inventor: Andrei Son, Timisoara (RO)

(73) Assignee: CONTINENTAL AUTOMOTIVE GMBH, Hannover (DE)

(21) Appl. No.: 15/416,437

(22) Filed: Jan. 26, 2017

(30) Foreign Application Priority Data
Sep. 2, 2016 (EP) 1644465504.5

(51) Int. Cl. G06K 9/00; H04N 7/18; G06T 7/20; G08G 1/16; B60W 10/20; B60W 10/184; B60W 30/09; B60W 30/095; G05D 1/02

(52) U.S. Cl. CPC G06K 9/00805; G05D 2201/0213; G06K 9/00362; G06T 7/20; G08G 1/166; B60W 10/20; B60W 10/184; B60W 30/09; B60W 30/0956; G05D 1/0238; G06T 2207/30196; G06T 2207/30261; B60W 2550/10; B60W 2710/20; B60W 2710/18; B60W 2420/42; H04N 7/183

(57) ABSTRACT

A driver assistance device for a vehicle includes an image acquisition unit for acquiring at least one image of a region of the surroundings which lies ahead of the vehicle. The drive assistance device includes an analyzing device configured to analyze at least one children-related object from the at least one image acquired by the image acquisition unit 3. The driver assistance device also includes a control device configured to initiate, as a function of a distance between the vehicle and the children-related object analyzed by the analyzing device, at least one measure to prevent a collision of the vehicle with a potentially emerging person associated with the children-related object.

### CROSS REFERENCE TO RELATED APPLICATION

This application claims the benefit of European patent application No. 16465504.5, filed Feb. 9, 2016, which is hereby incorporated by reference.

### TECHNICAL FIELD

The technical field relates to a driver assistance device for a vehicle.

### BACKGROUND

Modern driver assistance systems serve to assist the driver in dangerous situations in order to prevent an accident or at least mitigate the consequences of an accident. Children are often among casualties in road traffic. They often enter the road surprisingly for a driver. The most frequent mistakes occurring in accidents with children as pedestrians include suddenly crossing the road and in suddenly emerging, without paying attention to traffic, from behind obstacles that block the driver's view.

A method for assisting a driver of an automobile is known from publication EP 2400473 A1. At least one visual feature of an object is detected. The object is assigned to one of at least two object categories according to a first predetermined assessment on the basis of the at least one visual feature, wherein an assistance of the driver is classified as necessary for a first of the at least two object categories and an assistance of the driver is classified as unnecessary for a second of the at least two object categories.

It is desirable to present a system and method to achieve an increase in road safety for children. In addition, other desirable features and characteristics will become apparent from the subsequent summary and detailed description, and the appended claims, taken in conjunction with the accompanying drawings and this background.

### SUMMARY

A driver assistance device for a vehicle is configured, while the vehicle is in motion, to prevent or at least mitigate a collision with a person, especially with a child.

The driver assistance device includes an image acquisition unit for acquiring at least one image of a region of the surroundings which lies ahead of the vehicle. For example, the image acquisition unit is to be arranged/is arranged in the passenger compartment of the vehicle and/or outside on the vehicle body. The image acquisition unit may include at least one optical system for the projection of light and at least one image sensor (e.g., a CMOS sensor) for detecting the light projected by the optical system. For example, the image acquisition unit may include at least one or exactly one mono camera or stereo camera or may be designed as such a camera. The image acquisition unit may also be configured as a panoramic view camera system making 360° coverage around the vehicle possible utilizing a plurality of single cameras preferably having a large aperture angle.

The driver assistance device includes an analyzing device configured to analyze at least one child-related object from the at least one image acquired by the image acquisition unit. In particular, the analyzing device is designed to analyze a distance between the vehicle and the child-related object from the at least one acquired image. The image acquisition unit advantageously makes the acquisition of an image having high resolution and color information possible so that the child-related objects can be reliably analyzed.

The child-related object is preferably an object that is primarily used by children so that the child-related object particularly implies the presence of a child in road traffic. For example, the child-related object may be a stationary (motionless) object, e.g., a bicycle, a toy car or a skateboard standing on the verge or on the pavement. The child-related object may also be a moving object (e.g., a remote-controlled toy car) or a ball-shaped moving object (in particular, a basketball, a football, a volleyball, a tennis ball, or a shuttlecock).

The driver assistance device also includes a control device, wherein the control device is designed to initiate, as a function of the distance between the vehicle and the child-related object analyzed by the analyzing device, at least one measure to prevent a collision of the vehicle with a potentially emerging person associated with the child-related object, thus taking a preventive measure of collision protection with a potentially emerging person who is not or not yet visible to the driver and/or particularly to the analyzing device due to, e.g., an obstacle blocking the driver's view, e.g., a parking vehicle. Accordingly, collision prevention is particularly already initiated with respect to a person associated with the child-related object and not yet detected. In this manner, an early reaction of the driver and/or of the driver assistance device to children who might run into the area in front of the vehicle is to be made possible and the risk of accidents with children is thus to be reduced.

In one exemplary embodiment, the control device is configured to fix the limiting value of the distance as a function of the speed of the vehicle, of the condition of the pavement, and/or of the weather conditions. Both the condition of the pavement and adverse weather conditions affect, in particular, the braking behavior and/or the steering behavior of the vehicle so that the limiting value of the distance increases as, preferably, the speed of the vehicle increases, the condition of the pavement deteriorates, and/or the weather conditions deteriorate.

Particularly, the control device may be configured to initiate such a reduction in speed as the at least one collision prevention measure so that the vehicle can be stopped in time in the event of the emergence of the person associated with the child-related object. The reduction in speed thus serves to initiate a measure to prevent an accident or at least to mitigate the consequences of an accident without possibly creating unnecessary danger to surrounding traffic by intervening too intensively.

Furthermore, the control device may be configured to stop the vehicle in the event of the emergence of an analyzed person associated with the child-related object. An advantage of this implementation consists of the fact that, in particular, emergency braking is not performed until the danger of collision is imminent.

Alternatively or optionally additionally, the control device may be configured to initiate, in the event of the emergence of an analyzed person associated with the child-related object, a trajectory for an evasive maneuver of the vehicle with respect to said person. In other words, an intervention in the steering of the vehicle is performed in particular. In particular, the initiation of the trajectory for an evasive maneuver is advantageous if a collision with the associated person cannot be precluded even if a braking maneuver is to be initiated or has been initiated.

The analyzing device may be configured to analyze the person associated with the child-related object from the at least one image acquired by the image acquisition unit. For instance, a person is regarded as analyzed as the person associated with the child-related object if a distance between the person and the child-related object is smaller than a distance limiting value predetermined particularly by the analyzing device or is within a predetermined distance limiting value range, if a person approaches the stationary child-related object, and/or if the person and the moving child-related object have the same direction of movement.

A vehicle having a driver assistance device according to the preceding description is also disclosed and described herein.

A method for assisting a driver in driving a vehicle having a driver assistance device is also disclosed and described herein. The method includes acquiring at least one image, particularly a sequence of images, of a region of the surroundings which lies ahead of the vehicle. The method also includes analyzing a child-related object from the at least one acquired image, particularly by image processing algorithms. Furthermore, at least one measure to prevent a collision of the vehicle with a potentially emerging person associated with the child-related object is initiated as a function of an analyzed distance between the vehicle and the child-related object.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a schematic representation of a driver assistance device according to one exemplary embodiment;

FIG. 2 is a top view showing a vehicle having the driver assistance device for analyzing a child-related object according to one exemplary embodiment; and

FIG. 3 is a top view showing the driver assistance device for analyzing a person associated with the child-related object.

### DETAILED DESCRIPTION

Referring to the Figures, wherein like numerals indicate like parts throughout the several views, a driver assistance device 1 is shown and described herein.

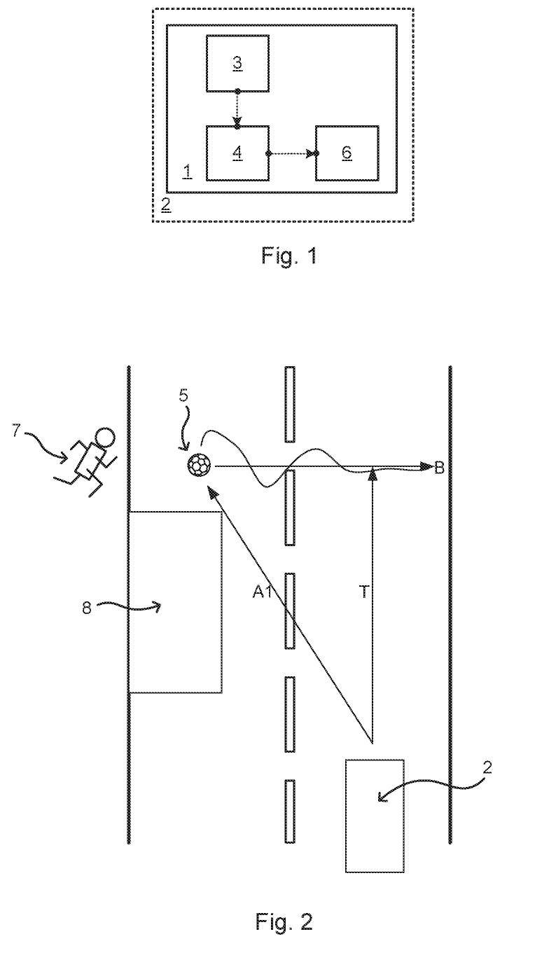

FIG. 1 shows a schematic block representation of the driver assistance device 1 arranged in a vehicle 2. The driver assistance device 1 is configured to assist a driver of the vehicle 2 during a potentially imminent collision with a person, particularly with a child.

The driver assistance device 1 includes an image acquisition unit 3 for acquiring at least one image of a region of the surroundings which lies ahead of the vehicle 2. For example, the image acquisition unit 3 may include at least one front camera for covering the region of the surroundings which lies ahead. The front camera is, e.g., a stereo camera.

The driver assistance device 1 has an analyzing device 4, wherein the image acquisition unit 3 is connected to the analyzing device 4 for transmitting the at least one image. The analyzing device 4 is designed to analyze a child-related object 5 (i.e., particularly an object that is attractive to a child, especially a toy) from the at least one image transmitted by the image acquisition unit 3. Thus, the child-related object 5 is preferably an object that implies the presence of a child in the surroundings. The child-related object 5 may be a stationary object (e.g., a parked bicycle) or a moving object (e.g., a ball). For example, the child-related object 5 is analyzed by means of a color algorithm and/or a pattern algorithm. Furthermore, the analyzing device 4 is designed to analyze a distance A1 between the vehicle 2 and the object 5 from the at least one image transmitted by the image acquisition unit 3, said object 5 being analyzed by the analyzing device 4.

Children like using the traffic area as a place for playing and as a meeting place for group activities, wherein they are often unable to correctly assess the risks and danger inherent in road traffic. With this in mind, the driver assistance device 1 comprises a control device 6 designed to initiate, as a function of the distance A1 between the vehicle 2 and the object 5 analyzed by the analyzing device 4, a measure to prevent a collision of the vehicle 2 with a potentially emerging person 7 associated with the child-related object 5. In this manner, the number of road accidents with children, who often enter the road without paying attention to traffic, is to be reduced.

In particular, the collision prevention measure is an active intervention in the vehicle dynamics of the vehicle 2 by the control device 6. For example, the vehicle 2 is slowed down or stopped by taking off the gas and/or by initiating a braking maneuver. If, for example, the child-related object 5 is near the vehicle trajectory T, e.g., on the verge and at a distance to the vehicle trajectory T of less than five meters, the control device 6 is particularly designed to reduce speed such that the vehicle 2 can be stopped in time in the event of the emergence of the person 7 associated with the child-related object 5. For example, the vehicle trajectory T can be determined by means of the course of the traffic lane on the pavement on which the vehicle 2 is currently located, and/or on the basis of the steering direction chosen by the driver.

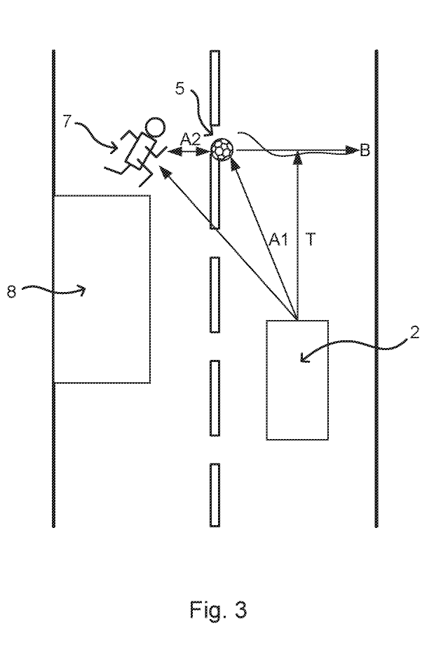

FIG. 2 shows an exemplary traffic scenario with a child 7 running toward the pavement in order to fetch a ball 5 but currently still located behind an obstacle 8 that blocks the driver's view so that the child is not visible to the driver and to the analyzing device 4.

The analyzing device 4 is configured to analyze the child-related object 5 (the ball in this exemplary embodiment). For example, the collision prevention measure, particularly the reduction in speed, has been initiated by the control device 6 if the analyzing device 4 has analyzed a distance A1 between the vehicle 2 and the child-related object 5 that is smaller than the predetermined distance limiting value. For example, the predetermined distance limiting value is fixed as a function of the speed of the vehicle, of the condition of the pavement, and/or of the weather conditions. For example, the speed of the vehicle is reduced such that the vehicle can be stopped in time in the event of the emergence (emerging from behind the obstacle 8 blocking the driver's view) of the person 7 (see FIG. 3).

In particular, the analyzing device 4 analyzes the person 7 associated with the child-related object 5 from the at least one acquired image. For example, a person is regarded as analyzed as the associated person 7 if the analyzing device 4 has analyzed a distance A2 between the child-related object 5 and the person 7 that is smaller than a predetermined distance limiting value. If the child-related object 5 is a moving object 5 (e.g., the football shown in FIG. 3), the analyzing device 4 is designed to analyze the directions of movement B of the moving object 5 and of the person 7. In particular, the person is regarded as analyzed as the associated person 7 if the moving object 5 and the person 7 have the same direction of movement B. For example, the direction of movement B of the moving object 5 and/or of the associated person 7 are analyzed from sequences of images of the images transmitted by the image acquisition unit 3.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A driver assistance device for a vehicle, comprising:
an image acquisition unit for acquiring at least one image of a region of the surroundings which lies ahead of the vehicle;
an analyzing device configured to analyze at least one child-related object from the at least one image acquired by the image acquisition unit; and
a control device configured to initiate, as a function of a distance between the vehicle and the child-related object analyzed by the analyzing device, at least one measure to prevent a collision of the vehicle with a potentially emerging person associated with the child-related object.

2. The driver assistance device according to claim 1, wherein the child-related object is a stationary object that is stationary.

3. The driver assistance device according to claim 2 wherein the stationary object is a bicycle.

4. The driver assistance device according to claim 2, wherein the stationary object is a skateboard.

5. The driver assistance device according to claim 1, wherein the child-related object is a moving object that is in motion.

6. The driver assistance device according to claim 5, wherein the moving object is a ball.

7. The driver assistance device according to claim 1, wherein the at least one collision prevention measure is initiated by the control device in response to the distance between the vehicle and the child-related object is less than a predetermined distance limiting value.

8. The driver assistance device according to claim 7, wherein the control device is configured to fix the predetermined distance limiting value as a function of at least one of the speed of the vehicle, the condition of the pavement, and the weather conditions.

6. The driver assistance device according to claim 1, wherein the control device is configured to initiate a reduction in speed as the at least one collision prevention measure so that the vehicle can be stopped in time in the event of the emergence of the person associated with the child-related object.

7. The driver assistance device according to claim 1, wherein the control device is configured to stop the vehicle in the event of an analysis of the person associated with the child-related object.

8. The driver assistance device according to claim 1, wherein a person is regarded as analyzed as the person associated with the child-related object if a distance between the person and the child-related object is smaller than a predetermined distance limiting value, if the person approaches the stationary object, and/or if the person and the moving object have the same direction of movement.

9. A vehicle having a driver assistance device, comprising:
an image acquisition unit for acquiring at least one image of a region of the surroundings which lies ahead of the vehicle;
an analyzing device configured to analyze at least one child-related object from the at least one image acquired by the image acquisition unit; and
a control device configured to initiate, as a function of a distance between the vehicle and the child-related object analyzed by the analyzing device, at least one measure to prevent a collision of the vehicle with a potentially emerging person associated with the child-related object.

10. A method for assisting a driver in driving a vehicle with a driver assistance device, comprising:
acquiring at least one image of a region of the surroundings which lies ahead of the vehicle;
analyzing at least one child-related object from the at least one acquired image; and
initiating at least one measure to prevent a collision of the vehicle with a potentially emerging person associated with the child-related object as a function of an analyzed distance between the vehicle and the child-related object.
